(19) United States
(12) Patent Application Publication
(10) Pub. No.: US 2006/0073337 A1
(43) Pub. Date: Apr. 6, 2006

(54) Conductive path made of metallic nanoparticles and conductive organic material

(76) Inventors: Krzysztof Nauka, Redwood City, CA (US); Chung Ching Yang, Saratoga, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/954,476

(22) Filed: Oct. 1, 2004

(51) Int. Cl. B05D 5/12

(52) U.S. Cl. 428/407; 423/403; 524/439; 427/100

(57) ABSTRACT

In a method of forming a conductive path on a substrate, a layer of metallic nanoparticles is printed on the substrate and a conductive organic material is also printed, such that the conductive organic material is interspersed with the layer of metallic nanoparticles to thereby enhance one or more electrical properties of the conductive path.

### BACKGROUND OF THE INVENTION

A monolithic integrated circuit (“IC”), an entire circuit contained on a single piece of semiconductor, is fabricated using a variety of techniques to form conductive paths on substrates. Monolithically integrated electronic devices have traditionally been fabricated using subtractive processes consisting of, deposition of continuous electrically conductive layers, then selective removal of the conductor by means of photolithography, and selective etching while the substrate is held at a relatively low temperature.

Another manufacturing technique involves the use of printers that deposit the individual conductive paths. In this additive process, the conductive paths are deposited using metallic nanoparticles suspended in a liquid medium. More particularly, the liquid medium containing the metallic nanoparticles is deposited in a controlled fashion from either a thermally or mechanically driven printer. After the liquid medium containing the metallic nanoparticles is deposited on a substrate, the liquid portion of the medium is removed by evaporation. A layer of closely spaced metallic nanoparticles typically remains to provide the conductive path. This approach allows lower processing costs and flexibility in conductive path fabrication as compared with the more traditional manufacturing techniques.

However, conductive paths fabricated through conventional printing techniques suffer certain disadvantages. One such disadvantage associated with these types of conductive paths is that their electrical resistance is often much higher than for conductive paths that are fabricated through the more traditional manufacturing techniques. Typically, the increase in resistance is caused by the boundaries that are formed between the nanoparticles. These boundaries can be completely discontinuous or they can be highly defective. Liquid residue and other impurities that often times remain on the surfaces of the nanoparticles after the liquid medium has evaporated can be another reason for the resistance increase.

As such, conventional printing techniques are unable to form conductive paths that have similar electrical properties to those conductive paths formed through more traditional IC manufacturing techniques. Therefore, a relatively inexpensive process that enables conductive paths to be formed having similar electrical properties as those formed through more traditional IC manufacturing techniques is desirable.

### SUMMARY OF THE INVENTION

In a method of forming a conductive path on a substrate, a layer of metallic nanoparticles is printed on the substrate and a conductive organic material is also printed, such that the conductive organic material is interspersed with the layer of metallic nanoparticles to thereby enhance one or more electrical properties of the conductive path.

### BRIEF DESCRIPTION OF THE DRAWINGS

Features of the present invention will become apparent to those skilled in the art from the following description with reference to the figures, in which:

FIG. 1 illustrates a conductive path formed using metallic nanoparticles and an organic material, according to an embodiment of the invention;

FIG. 2A illustrates a block diagram of a control system capable of controlling operations of a printing system, according to an embodiment of the invention;

FIG. 2B illustrates a block diagram of another control system capable of controlling operations of a printing system, according to another embodiment of the invention;

FIGS. 3A-3C illustrate flow diagrams of operational modes for depositing metallic nanoparticles and organic material to form a conductive path on a substrate, according to various embodiments of the invention;

FIG. 4 is a block diagram illustrating a computer system, which may be used as a platform for executing one or more of the functions of the printing control systems depicted, for instance, in FIGS. 2A and 2B; and

FIG. 5 illustrates a conductive path fabricated through conventional printing techniques.

### DETAILED DESCRIPTION OF THE INVENTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

In a printing process for fabricating conductive paths for monolithic integrated circuits (ICs), metallic nanoparticles are co-deposited with appropriate conductive organic material. The type of organic material employed may be selected to increase electrical conductivity through the conductive path. In this regard, the disclosed printing process enables fabrication of conductive paths having lower electrical resistance as compared with conductive paths fabricated through conventional printing techniques.

In one example, the metallic nanoparticles are deposited onto a substrate from a first printing source and the organic material is deposited onto the substrate from a second printing source. The first printing source and the second printing source may be operated substantially simultaneously to thus enable a conductive path to be formed with both the metallic nanoparticles and the organic material. Alternatively, the first printing source and the second printing source may be operated sequentially while the nature of the solvents used in both sources assures that the resulting layers include a desired mix of organic material and metallic nanoparticles. Thus, for instance, a layer of metallic nanoparticles may be deposited onto the substrate first during a pass by the first printing source and a layer organic material may be deposited onto the substrate substantially on the layer of metallic nanoparticles during a subsequent pass by the second printing source. As a further example, a layer of organic material may be deposited onto the substrate during a first pass by the second printing source and a layer of metallic nanoparticles may be deposited substantially on the layer of organic material during a subsequent pass by the first printing source.

In another example, the metallic nanoparticles may be immersed in the organic material with or without the use of a solvent. In this example, the organic material may comprise a liquid-type of composition, which may, for instance, harden after a period of time through polymerization by means of chemical reaction, or photo curing. Alternatively, the metallic nanoparticles and the organic material may both be immersed in a liquid medium designed to evaporate. In any respect, the metallic nanoparticles and the organic material may be deposited onto a substrate from a single printing source. As such, conductive paths having a desired mix of metallic nanoparticles and conductive organic material may be formed.

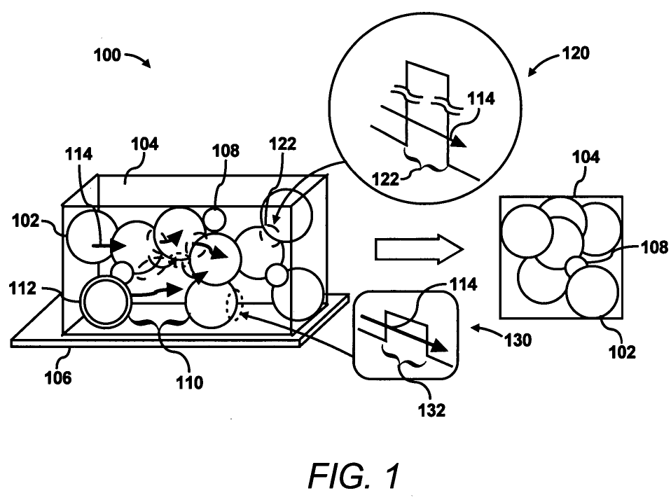

With reference first to FIG. 1, there is illustrated a conductive path 100 formed on a substrate 106 using metallic nanoparticles 102 and an organic material 104. The substrate 106 and the conductive path 100 may, for instance, form an integrated circuit. Although not explicitly illustrated in FIG. 1, the integrated circuit formed by the substrate 106 and the conductive path 100 may include additional components or elements without departing from a scope of the conductive path 100 and substrate 106.

The conductive path 100 may be formed through use of either of the printing control systems 200, 252 described herein below. In addition, or alternatively, the conductive path 100 may be formed through use of other inkjet printing technologies, silk-screen printing, electrophotographic, and photo-printing, etc.

The metallic nanoparticles 102 may comprise any reasonably suitable metallic nanoparticles known to be used in conductive path printing techniques. Thus, for instance, the metallic nanoparticles 102 may comprise Au, Ag, Cu, C, Al, W, Ti, Cr, Co, Ni, Pt, V, Ni, GA, In, Sn, Pd, Mo, Nb, Zr, and the like. The metallic nanoparticles 102 may also comprise a variety of metallic alloys suspended in water, and liquid alcohols (for instance, methanol), alkyl halides (for instance, isobutyl chloride), alkynes and their halogenated derivatives (for instance, 2-hexyne), ketones (for instance, acetone), amines (for instance, Methylamine), benzene and its derivatives, etc.

The organic material 104 may comprise any reasonably suitable conductive organic material that may be printed onto a substrate 106. Examples of suitable organic materials include conductive polymers, such as, polyanilines, doped polyanilines, polypyrroles, polythiophenes, thiophene oligomers, polyphenylene, and the like. The organic materials may be obtained from any major chemical supplier, such as, SIGMA-ALDRICH of St. Louis, Mo. and ALFA AESAR of Ward Hill, Mass. In general, however, the organic material 104 employed to form the conductive path 100 may be selected based upon a plurality of factors. For instance, an organic material 104 having good electrical conduction qualities as well as being capable of filling voids between the metallic nanoparticles 102 may be selected.

In addition, or alternatively, metallic nanoparticles 102 with appropriately functionalized surfaces may be used in various instances. Functionalization, in this case, means that metallic nanoparticles are coated with a layer of organic molecules, which provides one or more of the following functions: 1. substantially prevents agglomeration of the metallic nanoparticles by means of steric and electrostatic barriers; 2. substantially enhances interspersion of the metallic nanoparticles and the dispersion liquid(s). These functions may substantially be realized by coating the metallic nanoparticles with appropriate ligands, such as, alkyl, aryl, benzyl, alicyclic, heterocyclic, and the like groups. Examples of various processes where metallic nanoparticles have been treated with the functionalized surfaces may be found in U.S. patent Publication Nos. US2003/0118729A1 and US2003/0124259A1, the disclosures of which are hereby incorporated by reference in their entireties. In one example, the organic material 104 may be selected such that the selected functionalization helps to create a mixture of metallic nanoparticles 102 and binding agents that have desired electrical properties.

As shown in FIG. 1, the metallic nanoparticles 102 are configured in a somewhat random arrangement as may occur during any one of the above-identified printing processes of the metallic nanoparticles 102. Also shown are various impurities 108, which may exist in the conductive path 100. In addition, the organic material 104 is depicted as substantially filling the voids 110 between the metallic nanoparticles 102. As described in greater detail herein below, the organic material 104 generally increases the electrical conductivity characteristics of the conductive path 100.

Also illustrated in FIG. 1 is an optional coating 112 on one of the metallic nanoparticles 102. Although the optional coating 112 is shown on one metallic nanoparticle 102, the optional coating 112 may be applied to any number of metallic nanoparticles 102, including all of the metallic nanoparticles 102. As will be described in greater detail herein below, the optional coating 112 is applied to generally provide additional functionalization to the metallic nanoparticles 102.

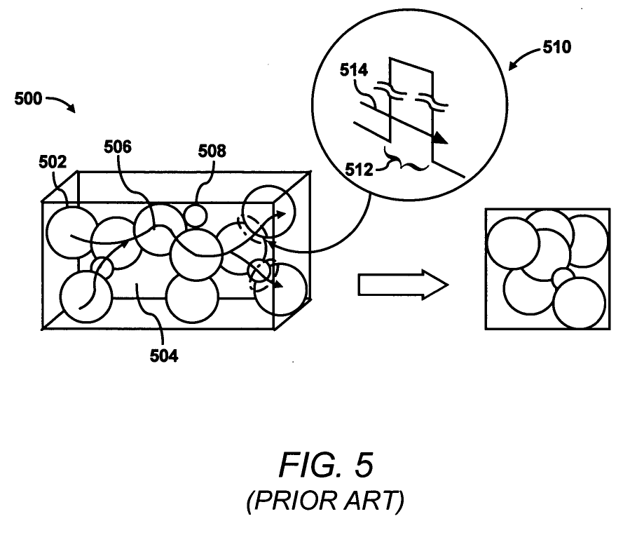

Various arrows depict the current flow 114 through the metallic nanoparticles 102 and the organic material 104. As shown, the current flow 114 is directed not only between the metallic nanoparticles 102, but also through the organic material 104. In this regard, the current flow 114 through the entire conductive path 100 is relatively stronger as compared with the current flow 506 through the conductive path 500 formed through conventional printing techniques, depicted in FIG. 5.

The portion of the conductive path 500 illustrated in FIG. 5 depicts a plurality of nanoparticles 502 arranged in a random order along a length of the conductive path 500. As shown, gaps 504 are formed between the nanoparticles 502, which often occur after evaporation of the liquid medium in which the nanoparticles 502 are immersed. In this regard, and as described in greater detail herein below, the current flow 506 through the conductive path 500 is relatively weak. In addition, residual liquid or other impurities 508 may remain at various locations of the conductive path 500.

The inset 510 depicts in greater detail the electronic structure of the interface 512 between two nanoparticles 502. As shown in the inset 510, at the interface 512, there is a potential barrier that electrons have to overcome in order to move from one nanoparticle 502 into another nanoparticle 502. Where there are very narrow barriers, electrons may tunnel through the barriers; however; when the barrier width is relatively large, current flows across the barriers become less probable.

With reference back to FIG. 1, as shown in the inset 120, the electrical conduction at an interface between two non-contacting metallic nanoparticles 102 may remain similar to the electrical conduction properties described with respect to the conductive path 500 illustrated in FIG. 5. However, as shown in the inset 130, which illustrates in greater detail an interface 132 between a metallic nanoparticle 102 and the organic material 104, the organic material 104 offers a much lower and narrower potential barrier as compared with the interface between non-contacting nanoparticles 502 in FIG. 5. Therefore, the interface shown in FIG. 1 creates a reduced level of resistance in the conductive path 100 due to, for instance, the nature of the selected organic material 104. Thus, the current flow 114 across the interface 132 is relatively higher than the current flow 506 across the interface 512 between non-contacting metallic nanoparticles 502.

Although the intrinsic resistivity of the organic material 104 is higher than the resistivity of the metallic nanoparticles 102, the overall resistivity of the conductive path 100 may be relatively lowered. Further, the organic material 104 may function as a “glue” and electrical filler, thereby improving the overall integrity of the conductive path 100. This generally enhances the chemical, mechanical and thermal stability of the nanoparticle environment, and provides better adhesion of the conductive path 100 to the substrate 106. In this regard, FIG. 1 demonstrates that the current flow 114 through the conductive path 100 generally encounters less resistance as compared with the conductive path 500 depicted in FIG. 5.

In addition, one or more agents (not shown) designed to assist in achieving a desired mixture of organic material 104 and metallic nanoparticles 102 may also be deposited with either or both of the metallic nanoparticles 102 and the organic material 104. The one or more agents may include, for instance, solvent, binder, wetting agent, etc., that generally improves mixing, adhesion and/or binding between the organic material and the nanoparticles. The one or more agents may be deposited from a separate printing source, or the one or more agents may be added to one or both of the organic material 104 printing source and the metallic nanoparticle 102 printing source.

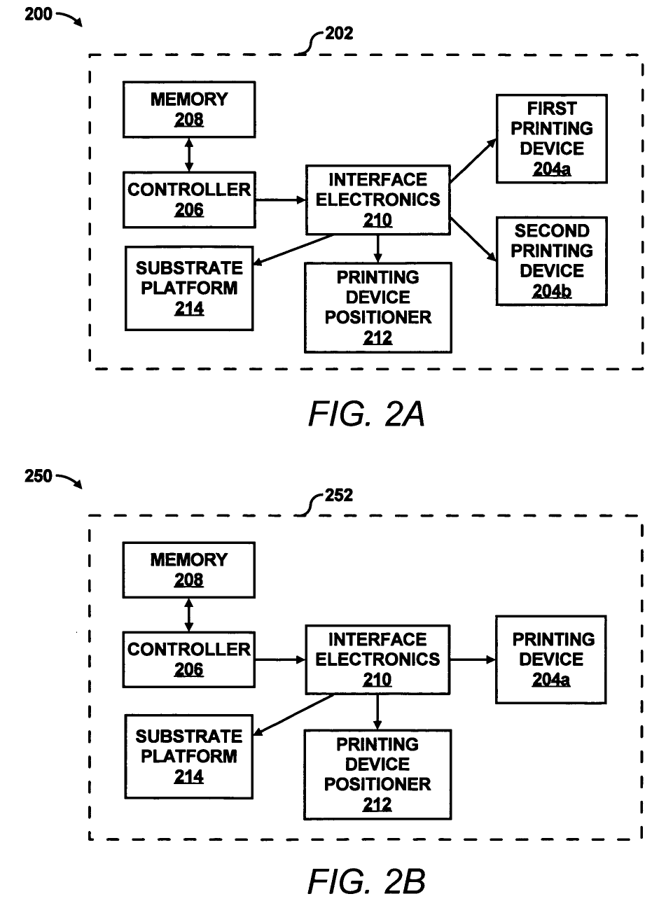

FIGS. 2A and 2B illustrate block diagrams 200, 250 of two respective printing control systems 202, 252 configured to deposit metallic nanoparticles 102 and an organic material 104. The following descriptions of the block diagrams 200, 250 are some manners of a variety of different manners in which such printing control systems 202, 252 may be configured. In addition, it should be understood that the block diagrams 200, 250 may include additional components and that some of the components described herein may be removed and/or modified without departing from scope of the control systems 202, 252 disclosed herein.

With reference first to FIG. 2A, the printing control system 202 is configured to control two printing sources, a first printing device, referenced as 204a, and a second printing device, referenced as 204b. Although the printing control system 202 is illustrated as containing two printing devices 204a and 204b, the control scheme depicted of the printing control system 202 may control any number of printing devices. For instance, the printing control system 202 may be configured to control a number of printing devices to thus enable co-deposition of more than two materials, for instance, metallic nanoparticles 102, a first organic material 104, a second organic material 104, a binder material, reaction chemical, etc. In addition, a larger number of printing devices may be employed to enable the substantially simultaneous deposition of a plurality of conductive paths 100 on the substrate 106. However, two printing devices 204a and 204b have been illustrated in FIG. 2A for purposes of simplicity.

As shown, the first printing device 204a and the second printing device 204b are configured to receive instructions or they are otherwise configured to be controlled by a controller 206. The controller 206 may comprise a microprocessor, a micro-controller, an application specific integrated circuit (ASIC), and the like. The controller 206 is generally configured to receive input from a user or a computer system and to control the first printing device 204a and the second printing device 204b in response to the received input. In determining manners in which to control the first printing device 204a and the second printing device 204b, the controller 206 may be configured to access a memory 208, which may contain algorithms or other software that the controller 206 may implement in controlling the first printing device 204a and the second printing device 204b. The memory 208 may comprise a traditional memory device, such as, volatile or non-volatile memory, such as DRAM, EEPROM, flash memory, combinations thereof, and the like.

Instructions and/or control signals from the controller 206 may be directed through interface electronics 210. In one regard, the interface electronics 210 may act as an interface between the controller 206 and various actuators (not shown) for the first printing device 204a and the second printing device 204b. The actuators may comprise, for instance, thermal or mechanical driving mechanisms associated with the printing devices 204a and 204b for controllably depositing material onto the substrate 106.

The controller 206 may also be configured to control the position of a printing device positioner 212 configured to vary the positions of one or both of the printing devices 204a and 204b. The controller 206 may further be configured to control the position of the substrate 106 through movement of a substrate platform 214. More particularly, the controller 206 may be configured to output control signals through the interface electronics 210 and to either or both of the various actuators (not shown) for varying the position of the printing device positioner 212 and/or the substrate platform 214.

In one example of the printing control system 202, the first printing device 204a may be configured to deposit metallic nanoparticles 102 suspended in a liquid medium. In addition, the second printing device 204b may be configured to deposit organic material 104. In this example, the controller 206 may be configured to operate the first printing device 204a and the second printing device 204b in a variety of different manners. For instance, the controller 206 may be configured to cause the first printing device 204a to deposit a layer of the metallic nanoparticles 102 suspended in the liquid medium and the second printing device 204b to deposit a layer of organic material 104 onto the layer of metallic nanoparticles 102. In a slight variation, the controller 206 may wait for a period of time after deposition of the metallic nanoparticles 102 suspended in the liquid medium and prior to depositing the organic material 104. This time may be used to enable the liquid medium to evaporate, either through heating or through normal evaporation techniques.

Alternatively, the controller 206 may operate the second printing device 204b to deposit a layer of organic material 104 onto the substrate 106 and the first printing device 204a to deposit a layer of metallic nanoparticles 102 suspended in liquid medium on the organic material layer. As a further variation, the controller 206 may operate the first printing device 204a and the second printing device 204b to substantially simultaneously deposit the metallic nanoparticles 102 suspended in liquid medium and the organic material 104.

With reference now to FIG. 2B, the printing control system 252 is illustrated as including a single printing device 204a. The printing control system 252 includes all of the components described hereinabove with respect to the printing control system 202 depicted in FIG. 2A. Therefore, a detailed description of the components forming part of the printing control system 202 is omitted and instead, the disclosure above with respect to the printing control system 202 is relied upon to provide a complete understanding of these components. However, as shown, the printing control system 252 is illustrated has having one printing device 204a instead of two printing devices.

In the printing control system 252, the printing device 204a is configured to co-deposit a mixture of metallic nanoparticles 102 and organic material 104 onto the substrate 106 to form the conductive path 100. In one respect, the organic material 104 and the metallic nanoparticles 102 may be suspended in the same liquid medium.

The metallic nanoparticles 102 and the organic material 104 may be deposited in manners to generally ensure that there is a relatively high degree of interspersion between the metallic nanoparticles 102 and the organic material 104. For instance, when the metallic nanoparticles 102 and the organic material 104 are sequentially deposited, the latter deposited material may be applied with sufficient force to generally enable the adequate interspersion of the materials. As another example, an additional agent may also be used to generally improve interspersion, adhesion, and/or binding between the metallic nanoparticles 102 and the organic material 104. In one respect, the additional agent may be deposited through use of a separate printing source. In another respect, the additional agent may be added to either or both of the metallic nanoparticles 102 and the organic material 104.

In addition, or alternatively, the interspersion of the metallic nanoparticles 102 and the organic material 104 may be promoted through use of other influences. These influences may include, for instance, mechanical shaking, ultrasound, heating, application of pressure, etc.

Although the printing control system 252 is depicted as including a single printing device 204a, the printing control system 252 may be configured with any reasonably suitable number of printing devices. Thus, for instance, if the printing control system 252 includes more than one printing device 204a, the printing control system 252 may be configured to deposit a number of conductive paths 100 in a substantially simultaneous manner.

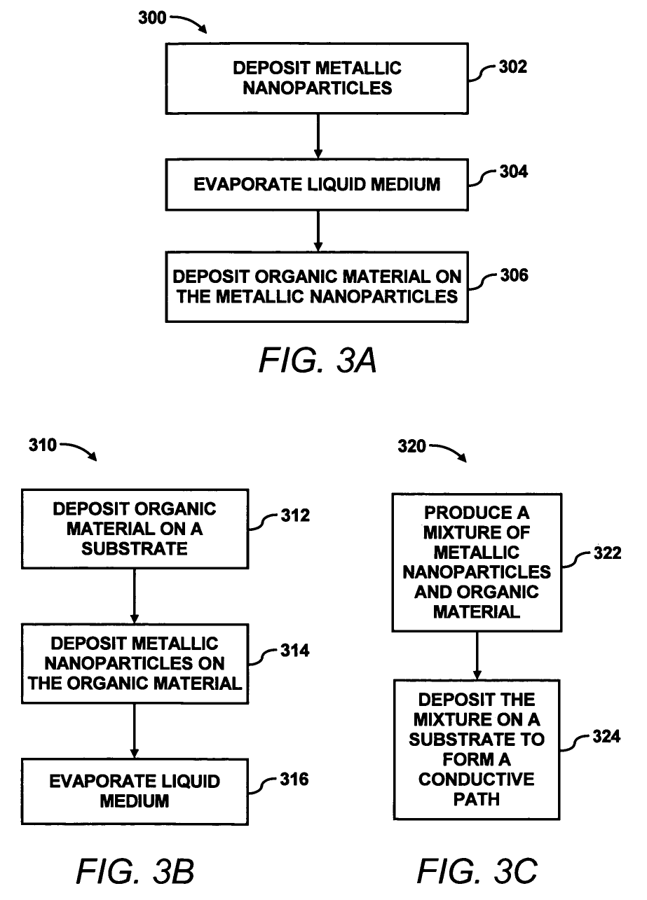

FIGS. 3A-3C illustrate flow diagrams of operational modes 300, 310, 320 for depositing metallic nanoparticles 102 and organic material 104 to form a conductive path 100 on a substrate 106. It is to be understood that the following description of the operational modes 300, 310, 320 are but a few manners of a variety of different manners in which the metallic nanoparticles 102 and organic material 104 may be deposited onto the substrate 106. It should also be apparent to those of ordinary skill in the art that the operational modes 300, 310, 320 represent generalized illustrations and that other steps may be added or existing steps may be removed, modified or rearranged without departing from a scope of deposition techniques disclosed herein.

The description of the operational modes 300, 310, 320 is made with reference to FIGS. 1, 2A, and 2B, and thus makes reference to the elements cited therein. It should, however, be understood that the operational modes 300, 310, 320 are not limited to the elements set forth in these figures. Instead, it should be understood that the operational modes 300, 310, 320 may be practiced by printing and control systems having different configuration than those set forth in FIGS. 1, 2A, and 2B.

With reference first to FIG. 3A, the operational mode 300 may employ a plurality of printing devices for depositing the metallic nanoparticles 102 and the organic material 104 onto the substrate 106. In this regard, the operational mode 300 may be practiced by the printing control system 202 depicted in FIG. 2A. Accordingly, the steps outlined in the operational mode 300 are described with respect to the printing control system 202.

At step 302, the controller 206 may operate the first printing device 204a to deposit a layer of metallic nanoparticles 102 onto the substrate 106. The metallic nanoparticles 102 may be suspended in a liquid medium to facilitate handling, ejection and deposition of the metallic nanoparticles 102 by the first printing device 204a. At step 304, the controller 206 may also wait for a predetermined period of time to enable the majority of the liquid medium to evaporate. Otherwise, the controller 206 may control a heating device configured to increase the speed at which the liquid medium evaporates.

Alternatively, step 304 may be omitted or performed following step 306. In this example, for instance, the steps 302 and 306 may be performed substantially concurrently. Thus, the controller 206 may operate the first printing device 204a and the second printing device 204b to deposit layers of the metallic nanoparticles 102 and the organic material 104 at substantially the same locations and at substantially the same times.

The controller 206 may then operate the second printing device 204b to deposit a layer of organic material 104 substantially on the layer of metallic nanoparticles 102 at step 306 to form the conductive path 100. The operational mode 300 may be performed concurrently on a number of printing devices 204a and 204b to thus form a plurality of conductive paths 100 substantially simultaneously. In addition, the operational mode 300 may be repeated a number of times to, for instance, increase the height and/or width of the conductive paths 100.

With reference now to FIG. 3B, the operational mode 310 may employ a plurality of printing devices for depositing the metallic nanoparticles 102 and the organic material 104 onto the substrate 106. In this regard, the operational mode 310 may be practiced by the printing control system 202 depicted in FIG. 2A. Accordingly, the steps outlined in the operational mode 300 are described with respect to the printing control system 202.

At step 312, the controller 206 may operate the first printing device 204a to deposit a layer of organic material 104 onto the substrate 106. At step 314, the controller 206 may operate the second printing device 204b to deposit a layer of metallic nanoparticles 102 suspended in a liquid medium substantially on the layer of organic material 104. At step 316, the controller 206 may control a heating device configured to increase the evaporation rate of the liquid medium in which the metallic nanoparticles 102 are immersed.

Alternatively, steps 312 and 314 may be performed substantially concurrently. Thus, the controller 206 may operate the first printing device 204a and the second printing device 204b to deposit layers of the metallic nanoparticles 102 and the organic material 104 at substantially the same locations and at substantially the same time.

Through the operational mode 310, a conductive path 100 may be formed. The operational mode 310 may be performed concurrently on a number of printing devices 204a and 204b to thus form a plurality of conductive paths 100 substantially simultaneously. In addition, the operational mode 310 may be repeated a number of times to, for instance, increase the height and/or width of the conductive paths 100.

In either of the operational modes 300 and 310, the metallic nanoparticles 102 and the organic material 104 may be deposited in manners to generally ensure that there is a relatively high degree of interspersion between the metallic nanoparticles 102 and the organic material 104. For instance, when the metallic nanopartcles 102 and the organic material 104 are sequentially deposited, the latter deposited material may be applied with sufficient force to generally enable the adequate interspersion of the materials. As another example, an additional agent (not shown) may also be used to generally improve interspersion, adhesion, and/or binding between the metallic nanoparticles 102 and the organic material 104. In one respect, the additional agent may be deposited through use of a separate printhead. In another respect, the additional agent may be added to either or both of the metallic nanoparticles 102 and the organic material 104.

In addition, or alternatively, the interspersion of the metallic nanoparticles 102 and the organic material 104 may be promoted through use of other influences. These influences may include, for instance, mechanical shaking, ultrasound, heating, application of pressure, etc. In this regard, these influences may be applied to the mixture of the metallic nanoparticles 102 and organic material 104 in either operational mode 300 and 310 after the mixture has been deposited onto substrate 106.

As shown in FIG. 3C, the operational mode 320 may employ a single printing device, for instance, printing device 204a, for depositing the metallic nanoparticles 102 and the organic material 104 onto the substrate 106. In this regard, the operational mode 300 may be practiced by the printing control system 252 depicted in FIG. 2B. Accordingly, the steps outlined in the operational mode 320 are described with respect to the printing control system 252.

As described hereinabove with respect to FIG. 2B, the printing device 204a is configured to deposit a mixture of metallic nanoparticles 102 and organic material 104. The metallic nanoparticles 102 may be immersed in the organic material 104. Alternatively, the metallic nanoparticles 102 and the organic material 104 may both be suspended in a liquid medium and may also include a solvent. As a further alternative, solvent may be deposited substantially concurrently or in a sequential manner with respect to the mixture of metallic nanoparticles 102 and organic material 104. In any respect, at step 322, a mixture of the metallic nanoparticles 102 and the organic material 304 may be produced.

At step 324, the controller 206 may operate the printing device 204a to deposit a layer of the mixture of metallic nanoparticles 102 and organic material 104 onto the substrate 106. In the event that the mixture is suspended in a liquid medium, the controller 206 may also control a heating device configured to increase the speed at which the liquid medium evaporates.

Through the operational mode 120, a conductive path 100 may be formed containing both the metallic nanoparticles 102 and the organic material 104. The operational mode 320 may be performed concurrently on a number of printing devices 204a to thus form a plurality of conductive paths 100 substantially simultaneously. In addition, the operational mode 320 may be repeated a number of times to, for instance, build up the height and/or width of the conductive paths 100.

Some or all of the operations set forth in the operational modes 300, 310, 320 may be contained as a utility, program, or subprogram, in any desired computer accessible medium. In addition, the operational modes 300, 310, 320 may be embodied by a computer program, which can exist in a variety of forms both active and inactive. For example, it can exist as software program(s) comprised of program instructions in source code, object code, executable code or other formats. Any of the above can be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM, DVD ROM, or via Internet download. In a sense, the Internet itself, as an abstract entity, is a computer readable medium. The same is true of computer networks in general. It is therefore to be understood that any electronic device capable of executing the above-described functions may perform those functions enumerated above.

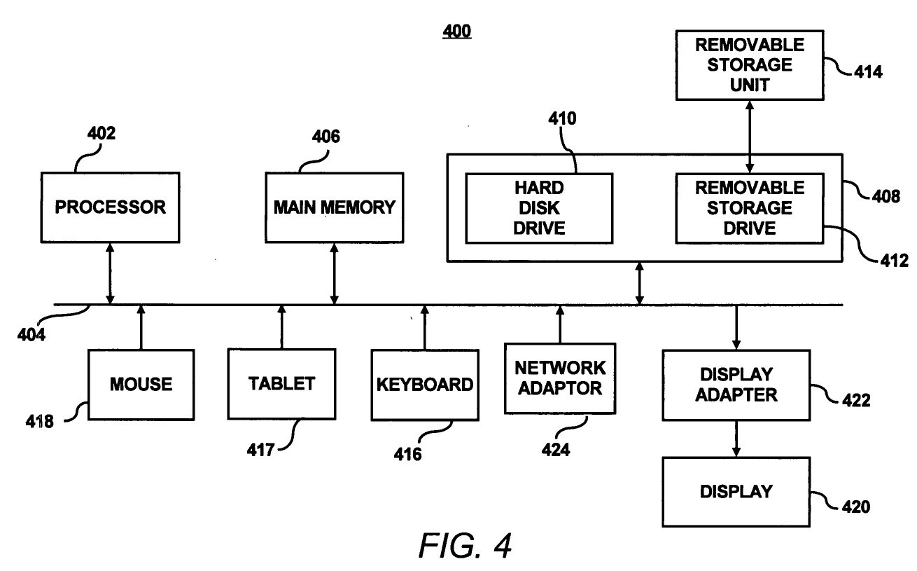

FIG. 4 illustrates a computer system 400, which may be used as a platform for executing one or more of the functions described hereinabove with respect to the various components of the printing control system 200, 252. In this respect, for instance, the computer system 400 may include, for example, the controller 206 of the printing control systems 200, 252 The computer system 400 includes one or more controllers, such as a processor 402. The processor 402 may be used to execute some or all of the steps described in one or more of the operational modes 300, 310, 320. Commands and data from the processor 402 are communicated over a communication bus 404. The computer system 400 also includes a main memory 406, such as a random access memory (RAM), where the program code for, for instance, the processor 402, may be executed during runtime, and a secondary memory 408. The secondary memory 408 includes, for example, one or more hard disk drives 410 and/or a removable storage drive 412, representing a floppy diskette drive, a magnetic tape drive, an optical disk drive, a flash memory, etc., where a copy of the program code for the provisioning system may be stored.

The removable storage drive 410 reads from and/or writes to a removable storage unit 414 in a well-known manner. User input and output devices may include a keyboard 416, a mouse 418, a tablet 417, and a display 420. A display adaptor 422 may interface with the communication bus 404 and the display 420 and may receive display data from the processor 402 and convert the display data into display commands for the display 420. In addition, the processor 402 may communicate over a network, for instance, the Internet, LAN, etc., through a network adaptor 424.

It will be apparent to one of ordinary skill in the art that other known electronic components may be added or substituted in the computer system 400. In addition, the computer system 400 may include a system board or blade used in a rack in a data center, a conventional “white box” server or computing device, a control system for a printing device, etc. Also, one or more of the components in FIG. 4 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method of forming a conductive path on a substrate, the method comprising:
printing a layer of metallic nanoparticles on the substrate; and
printing a conductive organic material, such that the conductive organic material is interspersed with the layer of metallic nanoparticles to thereby enhance one or more electrical properties of the conductive path.

2. The method according to claim 1, further comprising:
selecting the conductive organic material such that the conductive organic material enhances one or more electrical properties of the metallic nanoparticles.

3. The method according to claim 1, wherein the metallic nanoparticles are suspended in a liquid medium, the method further comprising:
printing the layer of metallic nanoparticles prior to the step of printing the conductive organic material; and
removing the liquid medium prior to the step of depositing the conductive organic material.

4. The method according to claim 1, wherein the metallic nanoparticles are suspended in a liquid medium, the method further comprising:
printing the layer of metallic nanoparticles prior to the step of printing the conductive organic material; and
removing the liquid medium following the step of depositing the conductive organic material.

5. The method according to claim 1, wherein the metallic nanoparticles are suspended in a liquid medium, the method further comprising:
removing the liquid medium through at least one of evaporation and heating.

6. The method according to claim 1, wherein:
the step of printing the metallic nanoparticles comprises depositing metallic nanoparticles using a first printing device; and
the step of printing the conductive organic material comprises depositing an organic material using a second printing device.

7. The method according to claim 1, further comprising:
coating the metallic nanoparticles with organic molecules configured to at least one of substantially prevent agglomeration of metallic nanoparticles by means of steric and electrostatic barriers and substantially enhance interspersion of the metallic nanoparticles and the conductive organic material.

8. The method according to claim 1, further comprising:
printing one or more agents configured to substantially enhance interspersion of the metallic nanoparticles and the conductive organic material.

9. The method according to claim 1, further comprising:
substantially enhancing interspersion of the conductive organic material and the metallic nanoparticles through application of at least one of mechanical shaking, ultrasound, heating, and pressure application.

10. The method according to claim 1, further comprising:
printing the conductive organic material prior to the step of printing the metallic nanoparticles.

11. The method according to claim 10, wherein the metallic nanoparticles are suspended in a liquid medium, the method further comprising:
removing the liquid medium following the step of depositing the conductive organic material.

12. The method according to claim 1, further comprising:
substantially simultaneously printing the metallic nanoparticles and the conductive organic material onto the substrate.

13. The method according to claim 12, wherein the step of substantially simultaneously printing the metallic nanoparticles and the conductive organic material comprises depositing the metallic nanoparticles using a first printing device and depositing the conductive organic material using a second printing device.

14. The method according to claim 12, wherein the step of substantially simultaneously depositing the metallic nanoparticles and the conductive organic material comprises depositing the metallic nanoparticles and the conductive organic material from a common printing device.

15. The method according to claim 14, further comprising:
producing a mixture of metallic nanoparticles and conductive organic material prior to the step of depositing the metallic nanoparticles and the organic material from the common printing device.

16. The method according to claim 15, wherein the step of producing the mixture comprises producing a mixture of metallic nanoparticles and conductive organic material in a liquid medium.

17. A system for forming a conductive path on a substrate, the system comprising:
metallic nanoparticles;
a conductive organic material configured to enhance one or more electrical properties of the metallic nanoparticles;
at least one agent configured to enhance one or more properties of the interactions between the metallic nanoparticles and the conductive organic material; and
at least one printing device configured to deposit the metallic nanoparticles, the conductive organic material and the at least one agent on the substrate to form a conductive path and thereby enhance one or more electrical properties of the conductive path.

18. The system according to claim 17, wherein the at least one printing device comprises a first printing device configured to deposit the metallic nanoparticles and a second printing device to deposit the conductive organic material.

19. The system according to claim 18, further comprising:
a controller operable to control the first printing device and the second printing device to thereby control metallic nanoparticle deposition and conductive organic material deposition.

20. The system according to claim 17, wherein the at least one printing device is configured to deposit a mixture of the metallic nanoparticles and the conductive organic material, to thereby substantially simultaneously deposit the metallic nanoparticles and the conductive organic material onto the substrate.

21. The system according to claim 17, wherein the one or both of the at least one printing device and the substrate are configured to move relative to each other to thereby enable conductive path formation at various locations on the substrate using the at least one printing device.

22. The system according to claim 17, wherein the at least one printing device comprises at least one printhead configured to deposit one or more of the metallic nanoparticles, the conductive organic material, and the at least one agent.

23. The system according to claim 17, wherein the organic material is a material that is at least one of intrinsically conductive and exhibits low resistance contact with the metallic nanoparticles.

24. The system according to claim 23, wherein the organic material comprises a material selected from the group consisting of polyanilines, doped polyanilines, polyprroles, polythiophenes, thiophene oligomers, and polyphenylene.

25. The system according to claim 17, the at least one agent comprises a material selected from the group consisting of alkyl, aryl, benzyl, alicyclic, and heterocyclic ligands.

26. An integrated circuit having a substrate, the circuit comprising:
at least one conductive path on the substrate, said conductive path comprising metallic nanoparticles and a conductive organic material, said conductive organic material being configured to enhance one or more electrical properties of the conductive path.

27. The integrated circuit of claim 26, further comprising:
at least one agent configured to enhance one or more properties of the interactions between the metallic nanoparticles and the conductive organic material.

28. A system for forming a conductive path on a substrate, said system comprising:
means for printing a layer of metallic nanoparticles on the substrate; and
means for printing a conductive organic material, such that the conductive organic material is interspersed with the layer of metallic nanoparticles to thereby enhance one or more electrical properties of the conductive path.

29. The system according to claim 28, further comprising:
control means for controlling the means for printing of the layer of metallic nanoparticles and the means for printing the conductive organic material.

30. The system according to claim 28, wherein the means for printing the layer of metallic nanoparticles and the means for printing the conductive organic material comprise a common means for printing a mixture of the metallic nanoparticles and the conductive organic material.

31. A computer readable storage medium on which is embedded one or more computer programs, said one or more computer programs implementing a method for forming a conductive path on a substrate, said one or more computer programs comprising a set of instructions for:
printing a layer of metallic nanoparticles on the substrate; and
printing a conductive organic material such that the conductive organic material is interspersed with the layer of metallic nanoparticles to thereby enhance one or more electrical properties of the conductive path.

32. The computer readable storage medium according to claim 31, said one or more computer programs further comprising a set of instructions for:
selecting the conductive organic material such that the conductive organic material enhances one or more electrical properties of the metallic nanoparticles.

33. The computer readable storage medium according to claim 31, said one or more computer programs further comprising a set of instructions for:
printing one or more agents configured to substantially enhance interspersion of the metallic nanoparticles and the conductive organic material.
